(19) United States
(12) Patent Application Publication
(10) Pub. No.: US 2017/0036382 A1
(43) Pub. Date: Feb. 9, 2017

(54) A MELT CONDITIONER

(71) Applicant: Husky Injection Molding Systems Ltd., Bolton (CA)

(72) Inventors: Wesley GROVE, Essex Junction, VT (US); Bruno Giuseppe SODARO, Erin (CA); Darrin Albert MACLEOD, Jeffersonville, VT (US)

(21) Appl. No.: 15/106,849

(22) PCT Filed: Jan. 20, 2015
(86) PCT No.: PCT/US15/11935

§ 371 Date: Jun. 21, 2016

Related U.S. Application Data
(60) Provisional application No. 61/931,150, filed on Jan. 24, 2014.

(51) Int. Cl. B29C 45/30; B29C 45/27

(52) U.S. Cl. CPC B29C 45/30; B29C 45/2725

(57) ABSTRACT

A melt conditioner is provided. The melt conditioner includes a melt conditioning body having a plurality of melt conditioning channels. The plurality of melt conditioning channels are located upstream of at least one manifold flow channel. Each melt conditioning channel is for conveying, in use a melt sub flow and is dimensioned to provide, in use, a conditioned melt sub flow having a thermal profile that accounts for a downstream geometry of the manifold flow channel.

### TECHNICAL FIELD

Non-limiting embodiments disclosed herein generally relate to injection molding systems and more particularly a melt conditioner for use in an injection molding system.

### BACKGROUND

Molding is a process by virtue of which a molded article can be formed from a molding material by using a molding system. Various molded articles can be formed by using a molding process, such as an injection molding process. An example of a molded article that can be formed, for example, from polyethylene terephthalate (PET) is a preform suitable for subsequent blow molding into a final shaped container.

A typical injection molding system includes (among other things): (i) a melt preparation apparatus, (ii) a clamp assembly, (iii) a mold assembly, and (iv) a melt distributor, e.g. a hot runner.

In the operation of a typical injection molding system, the melt preparation apparatus forces a desired amount of melt (i.e., molten molding material) into a mold cavity of the mold assembly. The melt may enter the mold cavity through a gate via the melt distributor. The melt distributor and the mold assembly are tools that may be sold separately from or together with injection molding systems.

### SUMMARY

In accordance with an aspect disclosed herein, there is provided a melt conditioner. The melt conditioner includes a melt conditioning body. The melt conditioning body includes a plurality of melt conditioning channels. The melt conditioning channels are located upstream of at least one manifold flow channel. Each melt conditioning channel conveys, in use, a melt sub flow and is dimensioned to provide, in use a conditioned melt sub flow having a thermal profile that accounts for a downstream geometry of the manifold flow channel. The melt conditioning body can be configured to provide a split-conditioned melt flow having an array of thermal profiles embedded therein.

As examples, the melt conditioner may be configured as a machine nozzle of a melt preparation apparatus, a sprue bushing of a melt distributor, or a melt distributor.

These and other aspects and features of non-limiting embodiments will now become apparent to those skilled in the art upon review of the following description of specific non-limiting embodiments in conjunction with the accompanying drawings.

### DETAILED DESCRIPTION OF THE DRAWINGS

The non-limiting embodiments will be more fully appreciated by reference to the accompanying drawings, in which:

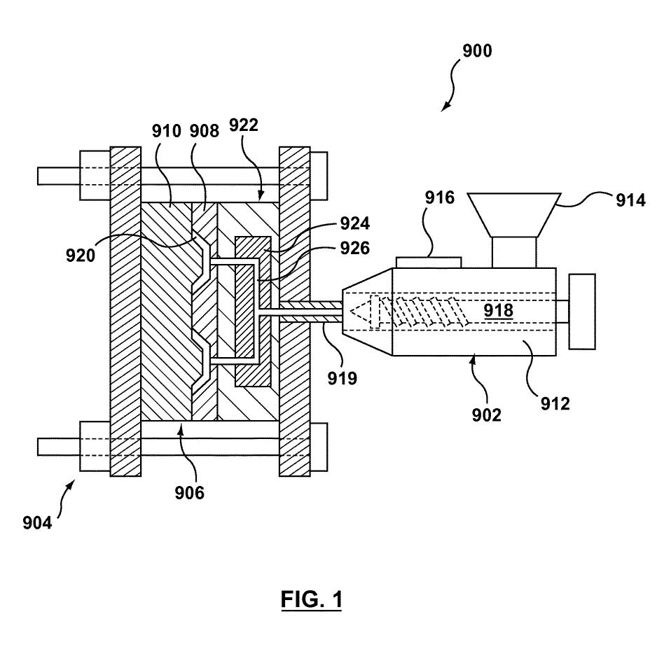

FIG. 1 is a schematic representation of an injection molding system according to a non-limiting embodiment;

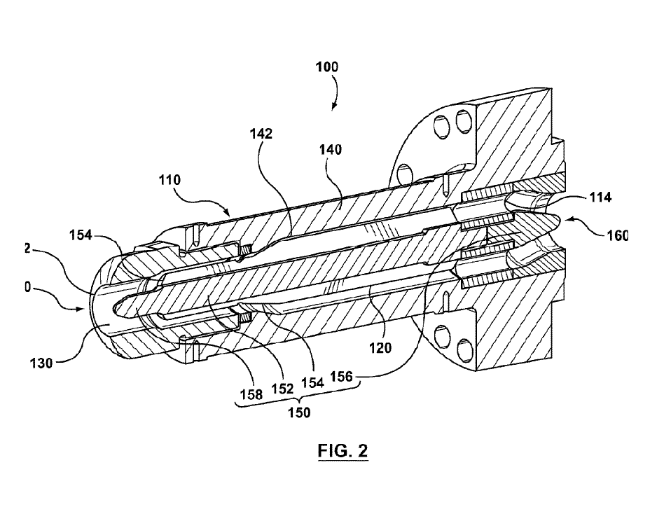

FIG. 2 is a cross-sectional view of a non-limiting example of a melt conditioner configured as a machine nozzle;

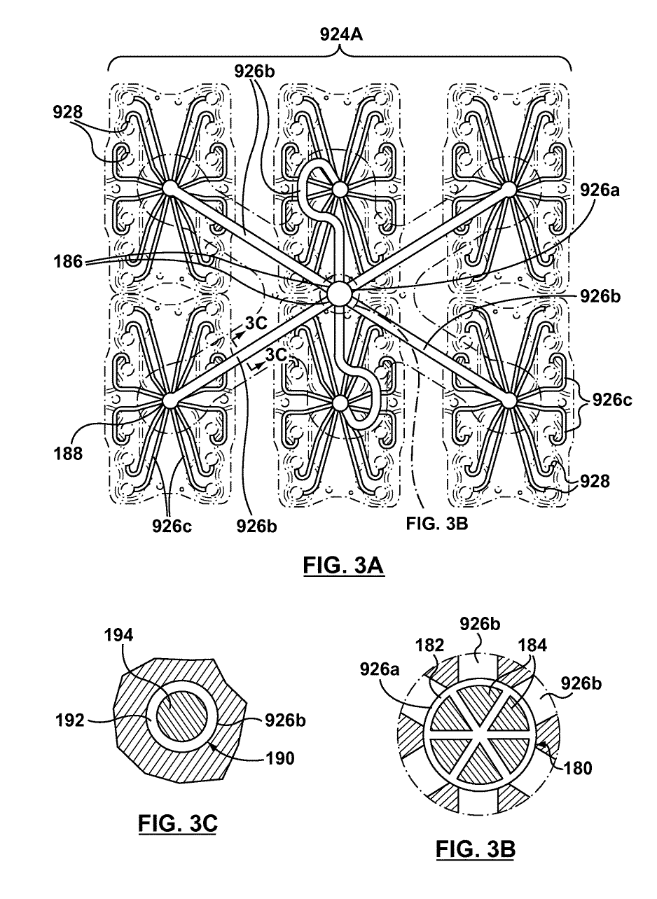

FIG. 3A is a plan view of a non-limiting example of a manifold assembly;

FIG. 3B is an enlarged view of an intake manifold flow channel of the manifold assembly of FIG. 3A with a representation of a thermal profile of a non-limiting split-conditioned melt flow provided by the melt conditioner of FIG. 2 superimposed thereon.

FIG. 3C is a cross-sectional view of an intermediary manifold flow channel of the manifold assembly of FIG. 3A taken along lines 3C-3C with a representation of a thermal profile of a non-limiting embodiment of a conditioned melt sub flow split from the split-conditioned melt flow of FIG. 3B superimposed thereon;

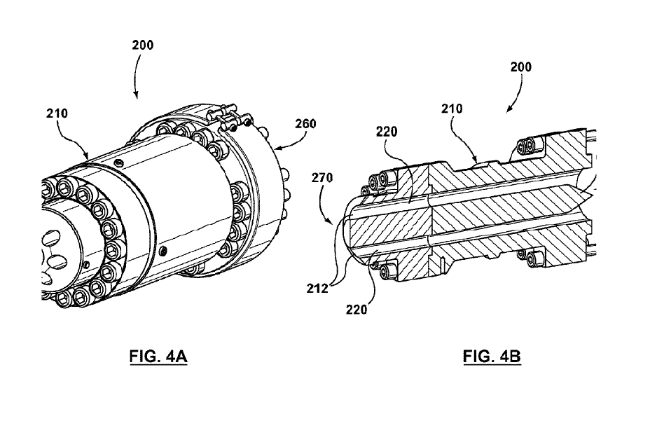

FIG. 4A is a perspective view of another non-limiting example of a melt conditioner configured as a machine nozzle;

FIG. 4B is a cross-sectional view of the melt conditioner of FIG. 4A;

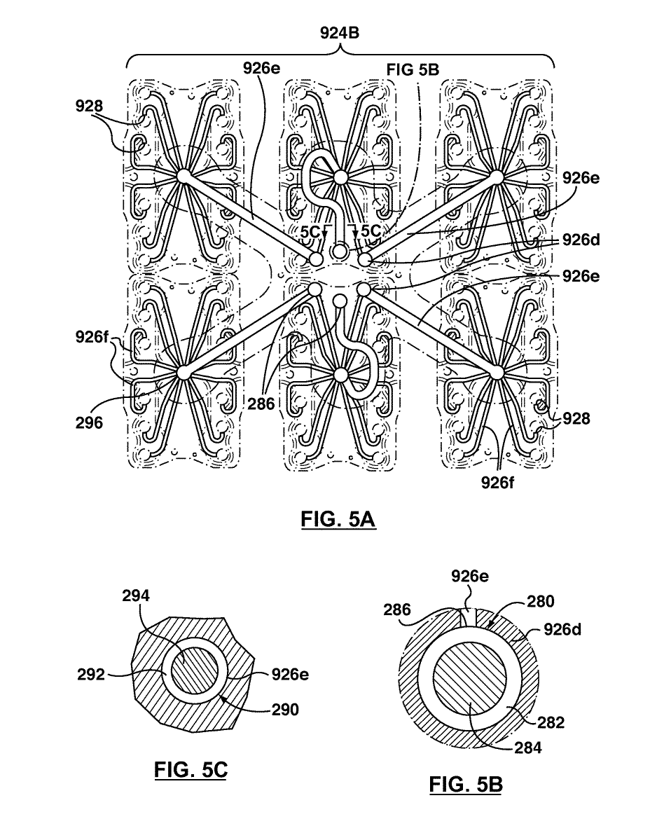

FIG. 5A is a plan view of another non-limiting embodiment of a manifold assembly;

FIG. 5B is an enlarged view of one intake manifold melt channel of the manifold assembly of FIG. 5A with a representation of a thermal profile of a non-limiting embodiment of a conditioned melt sub flow provided by the melt conditioner of FIGS. 4A and 4B superimposed thereon;

FIG. 5C is a cross-sectional view of an intermediary portion of a manifold melt channel of the manifold assembly of FIG. 5A taken along lines 5C-5C with a representation of a thermal profile of a non-limiting embodiment of a conditioned melt sub flow flowing therethrough superimposed thereon;

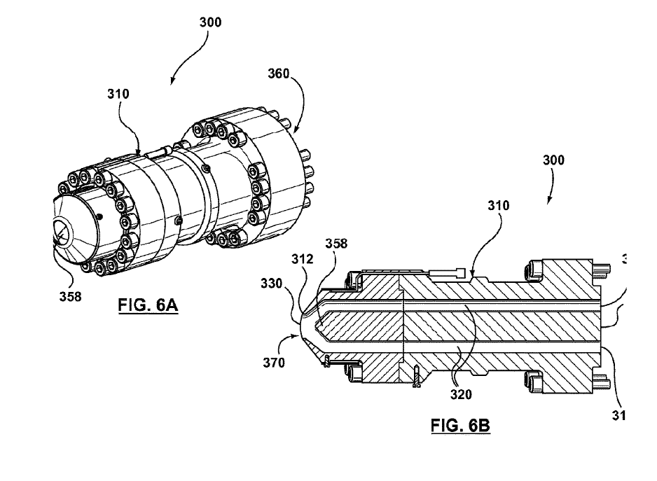

FIG. 6A is a perspective view of yet another non-limiting example of a melt conditioner configured as a machine nozzle;

FIG. 6B is a cross-sectional view of the melt conditioner of FIG. 6A;

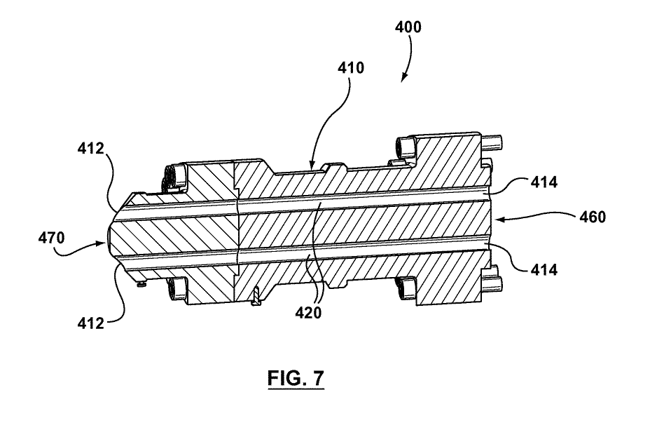

FIG. 7 is a cross-sectional view of another non-limiting example of a melt conditioner configured as a machine nozzle;

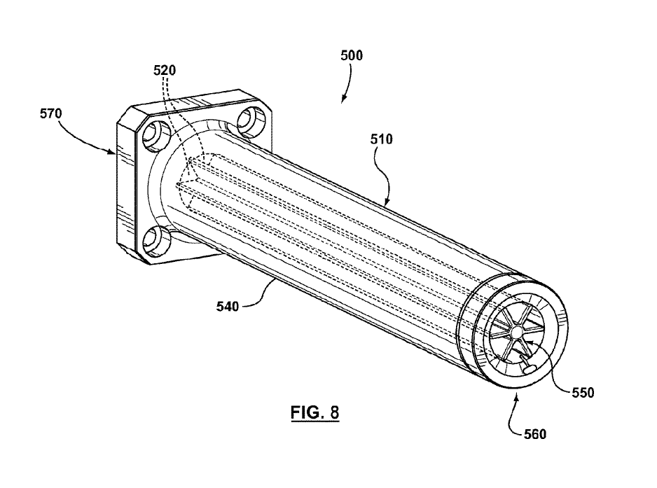

FIG. 8 is a perspective view of a non-limiting example of a melt conditioner configured as a sprue bushing;

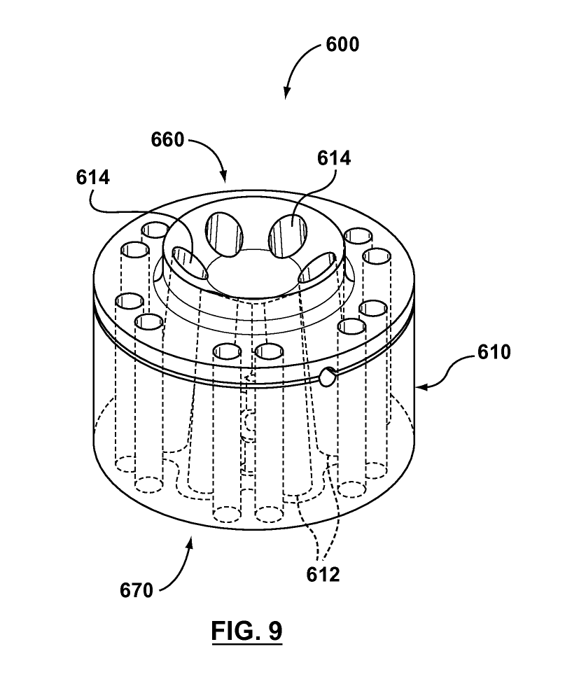

FIG. 9 is a perspective view of a non-limiting example of a melt conditioner configured as a sprue bushing; and

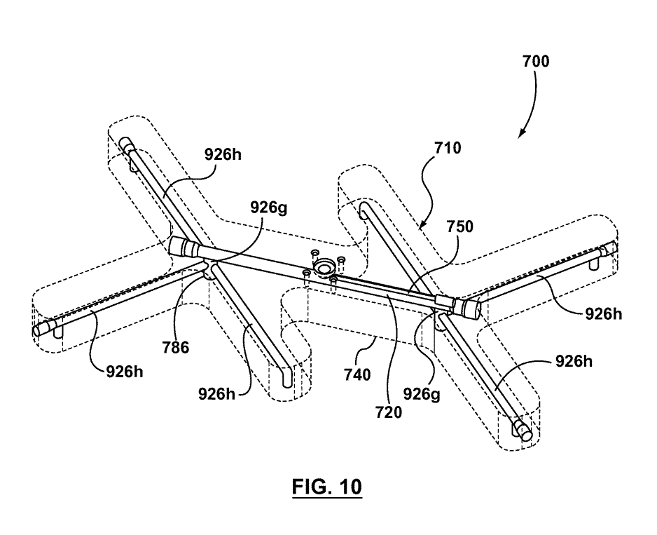

FIG. 10 is a perspective view of a non-limiting example of a melt conditioner configured as a melt distributor.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION OF EXEMPLARY EMBODIMENTS

Reference will now be made in detail to various non-limiting embodiment(s) of a melt conditioner for use in an injection molding system. It should be understood that other non-limiting embodiment(s), modifications and equivalents will be evident to one of ordinary skill in the art in view of the non-limiting embodiment(s) disclosed herein and that these variants should be considered to be within scope of the appended claims.

Furthermore, it will be recognized by one of ordinary skill in the art that certain structural and operational details of the non-limiting embodiment(s) discussed hereafter may be modified or omitted altogether. In other instances, well known methods, procedures, and components have not been described in detail.

Machine nozzles associated with melt preparation apparatuses, and sprue bushings associated with melt distributors, are commonly used in injection molding systems. It is generally known that a melt, typically a molten molding material such as, for example, PET, is not thermally homogeneous as it enters a mold cavity via at least one of a melt distributor (such as a hot runner), a machine nozzle and a sprue bushing. The lack of thermal homogeneity can be attributed to shear heating of the melt as it flows through one or more melt flow channels. The shear heating of the melt creates a non-uniform thermal flow-front having a boundary layer of hot melt adjacent to a surface of the melt flow channel, which surrounds a core of cooler melt at the center of the melt flow channel. Some injection molding systems incorporate a static mixer as a melt conditioner to re-mix this non-uniform thermal flow-front. However, it has been found that static mixers cannot achieve a perfectly uniform thermal flow-front due to inefficiencies in mixing.

FIG. 1 is a schematic representation of an injection molding system 900 in accordance with a non-limiting embodiment. Generally, the injection molding system 900 includes (amongst other things): (i) a melt preparation apparatus 902, (ii) a clamp assembly 904, (iii) a mold assembly 906, and (iv) a melt distributor 922. The melt preparation apparatus 902 may include a reciprocating-screw type injection unit, as depicted, including (amongst other things): (i) a barrel 912, (ii) a hopper 914, (iii) a barrel heater 916, and (iv) a screw 918. The mold assembly 906 may include (amongst other things): (i) a movable mold portion 910, and (ii) a stationary mold portion 908. The movable mold portion 910 and the stationary mold portion 908 cooperate to define a mold cavity 920. The melt distributor 922 includes a manifold assembly 924 defining at least one manifold flow channel 926 configured to convey, in use, a melt to the mold assembly 906. According to a non-limiting embodiment, the manifold flow channel 926 is interrupted, i.e. manifold flow channel 926 has at least one split between an inlet and outlets of the manifold assembly 924. According to another non-limiting embodiment, the manifold flow channel 926 is uninterrupted, i.e. manifold flow channel 926 is continuous between an inlet and an outlet of the manifold assembly 924.

In operation, the clamp assembly 904 closes the mold assembly 906 such that the mold cavity 920 is defined. The clamp assembly 904 is configured to apply a clamping force that squeezes the mold assembly 906 together as the mold cavity 920 is injected with the melt from the melt preparation apparatus 902. The melt may enter the melt distributor 922 via a machine nozzle 919. The melt may enter the mold cavity 920 via the melt distributor 922.

FIG. 2 depicts a cross-sectional representation of a non-limiting embodiment of the melt conditioner 100 configured as a machine nozzle. Accordingly, the melt conditioning body 110 has an upstream end 160 configured to be connected to a melt preparation apparatus 902 by means known in the art. The melt conditioning body 110 further includes a downstream end 170 configured to be connected to a melt distributor 922 by means known in the art. The melt conditioner 100 includes a melt conditioning body 110. As shown, the melt conditioning body 110 may be substantially cylindrically shaped. The melt conditioning body 110 may be made from any suitable material for a machine nozzle.

The melt conditioning body 110 includes a housing 140 and a flow divider insert 150. The housing 140 defines a melt passageway 142 that conveys melt, when in use, from the upstream end 160 to an outlet 112 at the downstream end 170. As depicted, the melt passageway 142 can be substantially cylindrically shaped. The diameter of the melt passageway 142 may vary along the length of the melt passageway 142.

The flow divider insert 150 is located, at least in part, within the melt passageway 142 of the housing 140 and cooperates therewith to define a plurality of melt conditioning channels 120. The flow divider insert 150 is configured to split, in use, a flow of melt through the melt passageway 142 into a plurality of melt sub flows. The flow divider insert 150 may have a longitudinal axis that is substantially coincident with a longitudinal axis of the melt passageway 142 and/or the housing 140. Furthermore, the housing 140 and the flow divider insert 150 may cooperate to define a recombination chamber 130 leading to the outlet 112. The flow divider insert 150 may be heated by a heating element (not shown) connected to the flow divider insert 150. Likewise, the housing 140 can be heated by a heating element (not shown) connected to the housing 140. As depicted in FIG. 2, the length of the flow divider insert 150 is substantially the same as the length of the housing 140. According to non-limiting embodiments (not shown), the length of the flow divider insert 150 is shorter than the length of the housing 140. According to yet another non-limiting embodiments (not shown), the length of the flow divider insert 150 is longer than the length of the housing 140.

The flow divider insert 150 includes an elongated central portion 152. The elongated central portion 152 can be a torpedo-like member. The flow divider insert 150 also includes a plurality of fins 154 extending radially from the elongated central portion 152. The plurality of fins 154 define, at least in part, the plurality of melt conditioning channels 120. As such, each melt conditioning channel 120 has a substantially triangular or sector shaped cross-section.

The flow divider insert 150 may additionally include a flow diverter 156 located upstream of the plurality of fins 154. The flow diverter 156 is configured to facilitate diverting the flow of melt to the plurality of melt conditioning channels 120. As an example and as shown, the flow diverter 156 may be substantially conically shaped.

The flow divider insert 150 may further include a flow recombination guide 158 located downstream of the plurality of fins 154. The flow recombination guide 158 is configured to facilitate combining the plurality of conditioned melt sub flows to produce a split-conditioned melt flow. The flow recombination guide 158 may be substantially conically shaped.

As illustrated, the melt conditioning body 110 may be an assembly of several parts, for example, the housing 140, the elongated central portion 152, the plurality of fins 154, the flow diverter 156, and the flow recombination guide 158 may be made as separate parts, then assembled together. Alternatively, some or all of the melt conditioning body 110 may be integrally formed. For example, some or all of the melt conditioning body 110 may be made using a solid freeform fabrication process (also known as an additive manufacturing process). Solid freeform fabrication (SFF) refers to any one of the techniques in a collection of techniques for manufacturing solid objects by the sequential delivery of energy and/or material to specified points in space to produce that solid. SFF is sometimes referred to as “rapid prototyping,” “rapid manufacturing,” “layered manufacturing,” and “additive fabrication.” It will be appreciated that SFF is sometimes referred to as freeform manufacturing (FFF). The following are a number of typical techniques for SFF: (A) electron beam melting to produce fully fused void-free solid metal parts from powder stock; (B) electron beam freeform fabrication to produce fully fused void-free solid metal parts from wire feedstock; (C) fused deposition modeling, in which hot plastic is extruded through a nozzle to build up a model; (D) laminated object manufacturing in which sheets of paper or plastic film are attached to previous layers by either sprayed glue, heating, or embedded adhesive, and then the desired outline of the layer is cut by laser or knife to produce a finished product that typically looks and acts like wood; (E) laser-engineered net shaping in which a laser is used to melt metal powder and deposit it on the part directly, which has the advantage that the part is fully solid and the metal alloy composition can be dynamically changed over the volume of the part; (F) POLYJET MATRIX™, which enables simultaneous jetting of multiple types of materials; (G) selective laser sintering, which uses a laser to fuse powdered metal, nylon, or elastomer, though additional processing is necessary to produce a fully dense metal part; (H) shape deposition manufacturing in which part and support materials are deposited by a printhead and then machined to near-final shape; (I) solid ground curing, which shines a UV light on an electrostatic mask to cure a layer of photopolymers and uses solid wax for support; (J) stereolithography, which uses a laser to cure liquid photopolymers; (K) three-dimensional printing, which encompasses many technologies of modern 3D printers, all of which use inkjet-like printheads to deposit material in layers and commonly includes, but is not limited to, thermal phase change inkjets and photopolymer phase change inkjets; and/or (L) robocasting, which involves depositing material from a robotically-controlled syringe or extrusion head.

A person skilled in the art will appreciate that the various parts may individually be made of any suitable material(s) and may have any suitable surface finish. According to a non-limiting embodiment, the flow divider insert 150 may include a material having a thermal conductivity that is different from the thermal conductivity of a material included in the housing 140. According to a non-limiting embodiment, the flow divider insert 150 may include a material having a thermal conductivity that is substantially the same as the thermal conductivity of a material included in the housing 140.

The flow divider insert 150 may be aligned in relation or relative to the manifold assembly 924 such that a flow of melt in the manifold flow channel 926, having entered the manifold flow channel 926 via the melt conditioning body 110 has a thermal profile of a predetermined shape that is properly oriented with respect to the split geometry of the manifold flow channel(s) 926 located downstream of the melt conditioning channels 120.

Each melt conditioning channel 120 is configured to impart a thermal profile to a flow of melt conveyed therein. As such, the plurality of melt conditioning channels 120 provide a plurality of conditioned melt sub flows.

Each melt conditioning channel 120 may be uninterrupted, i.e., each melt conditioning channel 120 may be a continuous channel with no splits, mixers or other such features designed to split or otherwise disturb the flow of melt. In addition, each melt conditioning channel 120 of the plurality of melt conditioning channels 120 may be substantially parallel in relation to one another. Furthermore, each melt conditioning channel may have a longitudinal axis that is substantially parallel to a longitudinal axis of the melt conditioning body 110. Alternatively, according to a non-limiting embodiment (not depicted), the plurality of melt conditioning channels 120 or a subset thereof may trace a path of any other suitable course, for example a helical or spiral path between the upstream end 160 and the downstream end 170.

In addition, as depicted, the cross-sectional area of each melt conditioning channel 120 can vary along a length thereof. According to an alternative non-limiting embodiment (not depicted), the cross-sectional area of each melt conditioning channel 120 can be substantially constant along a length thereof. The length of each melt conditioning channel 120 can be greater than its width. Further, the length of each melt conditioning channel 120 is sufficient for conditioning a flow of melt. Each melt conditioning channel 120 is dimensioned (i.e., shaped and sized) to develop a thermal profile or melt thermal flow front that takes into account, and may be optimized to, the geometry of the manifold melt channel(s) 926 located downstream of the melt conditioning channel 120. For example, the thermal profiles of the conditioned melt sub flows can be optimized to take advantage of the split geometries of the manifold flow channel(s) 926 so as to reduce molding material thermal and mass imbalance between mold cavities 920. The thermal profiles of the conditioned melt sub flows may therefore not be thermally uniform, but are predictable or predetermined.

The melt conditioning body 110, as depicted in FIG. 2, defines a recombination chamber 130 located immediately downstream of the plurality of melt conditioning channels 120. In use, the plurality of conditioned melt sub flows are combined in the recombination chamber 130 to produce the split-conditioned melt flow, which has a predictable or predetermined thermal profile.

As used herein, the term “split-conditioned melt flow” is defined as a melt flow that has been produced by: (i) splitting a flow of melt into a plurality of melt sub flows, (ii) conditioning each melt sub flow such that a thermal profile is imparted thereto; and (iii) recombining the plurality of conditioned melt sub flows into a split-conditioned melt flow having an array of thermal profiles embedded therein.

FIG. 3A is a plan view of a non-limiting embodiment of a manifold assembly 924A. The manifold assembly 924A defines manifold flow channels 926a, 926b, 926c for conveying melt received from a melt conditioner, such as melt conditioner 100 (FIG. 2) to a plurality of manifold flow channel outputs 928 (sometimes referred to as drops). Intake manifold flow channel 926a receives the split-conditioned melt flow from the melt conditioner 100. Intake manifold flow channel 926a branches into six intermediary or branch manifold flow channels 926b at a first split 186. Each of intermediary manifold flow channels 926b branch at a second split 188 into twelve drop manifold flow channels 926c. Those skilled in the art will appreciate that the manifold assembly 924A can be designed to have any suitable number of branches in manifold flow channels 926a, 926b, 926c and any suitable number of manifold flow channel outputs 928.

FIG. 3B is an enlarged view of the intake manifold flow channel 926a of the manifold assembly 924A of FIG. 3A and superimposed thereon is a representation of a thermal profile 180 of the split-conditioned melt flow provided by melt conditioner 100 (FIG. 2), upstream from a first split 186, when in use. As shown, the split-conditioned melt flow provided by the melt conditioner 100 has an array of six substantially triangular or sector shaped thermal profiles embedded therein, one for each branch manifold flow channel 926b. In another embodiment (not shown), the split-conditioned melt flow provided by the melt conditioner 100 may have an array of seventy-two thermal profiles embedded therein corresponding to the number of manifold flow channel outputs 928, which is a factor of six. Each thermal profile of the array of thermal profiles may, but need not be substantially the same. Due to the shear heating imparted to each melt sub flow by the wall or walls of the melt conditioning channels 120 of the melt conditioner 100, each thermal profile of the array of thermal profiles in the thermal profile 180 can be divided into at least a first thermal zone 182 and a second thermal zone 184. The first thermal zone 182 may surround the second thermal zone 184 and the first thermal zone 182 may be relatively hotter than the second thermal zone 184.

In this embodiment, the split-conditioned melt flow provided by the melt conditioner 100 is split into a plurality of conditioned downstream melt sub flows by splitting or branching of the intake manifold flow channel 926a into the intermediary manifold flow channels 926b at the first split 186. FIG. 3C is a cross-sectional view of an intermediary manifold flow channel 926b and superimposed thereon is a representation of a thermal profile 190 of one of the conditioned downstream melt sub flow split from the split-conditioned melt flow and conveyed by one of the intermediary manifold flow channels 926b. The thermal profile 190 of each conditioned downstream melt sub flow may, but need not have substantially the same thermal profile. Due to the shear heating imparted to the plurality of conditioned melt sub flows by the walls of the melt conditioning channels 120 and the manifold flow channels 926a, 926b, the thermal profile of each conditioned melt sub flow can be divided into at least a first thermal zone 192 and a second thermal zone 194. The first thermal zone 192 and the second thermal zone 194 may be concentric and the first thermal zone 192 may surround the second thermal zone 194, the first thermal zone 192 being relatively hotter than the second thermal zone 194.

FIGS. 4A and 4B depict another non-limiting embodiment of a melt conditioner 200 configured as a machine nozzle, similar in many respects to the melt conditioner 100 described above. Accordingly, the melt conditioning body 210 includes an upstream end 260 configured to be connected to a melt preparation apparatus 902 (FIG. 1), and a downstream end 270 configured to be connected to a melt distributor 922 (FIG. 1).

The melt conditioner 200 includes a melt conditioning body 210. The melt conditioning body 210 defines a plurality of melt conditioning channels 220. As depicted, each melt conditioning channel 220 is substantially cylindrically shaped having a substantially circular shaped cross-section. Alternatively, one or more of the melt conditioning channels 220 can have an oval cross-section or any other suitably shaped cross-section.

The melt conditioning body 210 also defines a flow diverter 256 at the upstream end 260. In the illustrated embodiment, the flow diverter 256 is integrally formed with the melt conditioning body 210. The melt conditioning body 210 also defines a plurality of melt outlets 212 at the downstream end 270. Each melt conditioning channel 220 is associated with a respective melt outlet 212. In the illustrated embodiment, the melt conditioning channels 220 are uninterrupted and the conditioned melt sub flows are not recombined prior to entry into the melt distributor 922 (FIG. 1).

FIG. 5A is a plan view of another non-limiting embodiment of a manifold assembly 924B. The manifold assembly 924B defines manifold flow channels 926d, 926e, 926f for conveying melt received from a melt conditioner, such as melt conditioner 200 (FIGS. 4A & 4B) to a plurality of manifold flow channel outputs 928. In this embodiment, six intake manifold flow channels 926d receive six conditioned melt sub flows from six melt outlets 212 of the melt conditioner 200. In the illustrated embodiment, there is a first redirection or bend 286 in each intake manifold flow channel 926d. An intermediary portion 926e of each intake manifold flow channels 926d conveys melt to a first split 296 where the intake manifold flow channel 926d branches into twelve drop manifold flow channels 926f leading to the manifold flow channel outputs 928.

FIG. 5B is an enlarged view of one of the intake manifold follow channels 926e of the manifold assembly 924B of FIG. 5A and superimposed thereon is a representation of a thermal profile 280 of the conditioned melt sub flow provided by the melt conditioner 200 (FIGS. 4A & 4B), upstream from the first bend 286, when in use. Due to the shear heating imparted to each melt sub flow by the walls of the melt conditioning channels 220 of the melt conditioner 200, each thermal profile 280 can be divided into at least a first thermal zone 282 and a second thermal zone 284. The first thermal zone 282 may surround the second thermal zone 284 and the first thermal zone 282 may be relatively hotter than the second thermal zone 284. The first thermal zone 282 and the second thermal zone 284 may be concentric.

FIG. 5C is a cross-sectional view of an intermediary portion 926e of one of the intake manifold flow channels 926d and superimposed thereon is a representation of a thermal profile 290 of one of the conditioned melt sub flows conveyed in the intermediary portion 926e. The thermal profile 290 of each conditioned melt sub flow may, but need not have substantially the same thermal profile. The thermal profile 290 of each conditioned melt sub flow can be divided into at least a first thermal zone 292 and a second thermal zone 294. The first thermal zone 292 and the second thermal zone 294 may be concentric and the first thermal zone 292 may surround the second thermal zone 294, the first thermal zone 292 being relatively hotter than the second thermal zone 294

Each of the conditioned melt sub flows are split into a plurality of conditioned downstream melt sub flows by splitting or branching of the intermediary portion 926e of the intake manifold flow channel 926d into the drop manifold flow channels 926f at the first split 296.

FIGS. 6A and 6B depict another embodiment of a melt conditioner 300 configured as a machine nozzle. The melt conditioner 300 includes a melt conditioning body 310 that is substantially the same as the melt conditioning body 210 except for the differences described hereinbelow. As in melt conditioning body 210, the melt conditioning body 310 defines a plurality of melt conditioning channels 320, an upstream end 360 configured to be connected to a melt preparation apparatus 902 (FIG. 1), and a downstream end 370 configured to be connected to a melt distributor 922 (FIG. 1).

However, the melt conditioning body 310 does not include a flow diverter 156, 256 (FIGS. 2 & 4B). Flow of melt must therefore be split into melt sub flows upstream of the melt conditioner 300. The melt conditioning body 310 defines a plurality of melt inlets 314 at the upstream end 360 to receive the melt sub flows and an outlet 312. Each melt conditioning channel 320 is associated with a respective melt inlet 314.

Similar to melt conditioner 100, the melt conditioning body 310 also defines a recombination chamber 330 located immediately downstream of the plurality of melt conditioning channels 320. At the downstream end 370, the melt conditioning body 310 includes a flow recombination guide 358, which defines, at least in part, the recombination chamber 330. In use, the plurality of conditioned melt sub flows are combined in the recombination chamber 330 to produce a split-conditioned melt flow, which exits the melt conditioning body 310 via the outlet 312. The split-conditioned melt flow can be split into a plurality of conditioned downstream melt sub flows by the melt distributor 922 FIG. 1), such as by splitting or branching of an intake manifold flow channel in a similar fashion to that shown in FIG. 3A. Additionally or alternatively, the split-conditioned melt flow can be split into a plurality of conditioned downstream melt sub flows by a sprue bushing (not shown). For example, an intake flow channel defined in the sprue bushing may branch or split into a plurality of outlet flow channels defined in the sprue bushing. The number of outlet flow channels defined in the sprue bushing corresponding with the number of intake manifold flow channels defined in the manifold assembly, an example embodiment of which may be that shown in FIG. 5A.

FIG. 7 depicts another non-limiting embodiment of a melt conditioner 400 configured as a machine nozzle. The melt conditioner 400 includes a melt conditioning body 410 that is substantially the same as the melt conditioning bodies 210 and 310 (FIGS. 4A & 6A) except for the differences described hereinbelow. As in melt conditioning bodies 210 and 310, the melt conditioning body 410 defines a plurality of melt conditioning channels 420. The melt conditioning body 410 has an upstream end 460 configured to be connected to a melt preparation apparatus 902 (FIG. 1), and a downstream end 470 configured to be connected to a melt distributor 922 (FIG. 1).

However, the melt conditioning body 410 does not include a flow diverter 156, 256 (FIGS. 2 & 4B) or a recombination chamber 130, 330 (FIGS. 2 & 6B). Flow of melt must therefore be split into melt sub flows upstream of the melt conditioner 400. The melt conditioning body 410 defines a plurality of melt inlets 414 at the upstream end 460 to receive the melt sub flows. The melt conditioning body 410 also defines a plurality of melt outlets 412 at the downstream end 470. Each melt conditioning channel 420 is associated with a respective melt inlet 414 and a respective melt outlet 412.

FIG. 8 depicts a non-limiting embodiment of a melt conditioner 500 configured as a sprue bushing. The melt conditioner 500 includes a melt conditioning body 510. The melt conditioning body 510 includes an upstream end 560 configured to be connected to a machine nozzle of the melt preparation apparatus 902 (FIG. 1) by means known in the art. The melt conditioning body 510 further includes a downstream end 570 configured to be connected to a manifold assembly 924 (FIG. 1) by means known in the art. The melt conditioning body 510 may be made from any suitable material for a sprue bushing.

The melt conditioning body 510 may be substantially cylindrically shaped and includes a housing 540 and a flow divider insert 550 located within the housing 540. The flow divider insert 550 is similar to the flow divider insert 150 (FIG. 2) and is thus configured to split, in use, a flow of melt into a plurality of melt sub flows. Flow divider insert 550 cooperates with housing 540 to define a plurality of melt conditioning channels 520 as in melt conditioner 100 (FIG. 2).

FIG. 9 depicts another non-limiting embodiment of a melt conditioner 600 configured as a sprue bushing. Accordingly, the melt conditioning body 610 includes an upstream end 660 configured to be connected to a machine nozzle of the melt preparation apparatus 902 (FIG. 1) by means known in the art, and a downstream end 670 configured to be connected to a manifold assembly 924 (FIG. 1) by means known in the art.

The melt conditioner 600 includes a melt conditioning body 610 similar to the melt conditioning body 410 (FIG. 7). The melt conditioning body 610 includes a plurality of melt conditioning channels 620. The melt conditioning channels 620 are defined by the melt conditioning body 610. The melt conditioning body 610 also defines a plurality of melt inlets 614 defined at an upstream end 660 thereof, and a plurality of melt outlets 612 defined at a downstream end 670 thereof. Each melt conditioning channel 620 is associated with a respective melt inlet 614 and a respective melt outlet 612.

FIG. 10 depicts a non-limiting embodiment of a melt conditioner 700 configured as a melt distributor, such as, for example, a hot runner. The melt conditioner 700 includes a melt conditioning body 710, which may be configured as a manifold assembly. The melt conditioning body 710 includes a housing 740 and a flow divider insert 750 located within the housing 740. The flow divider insert 750 is configured to split, in use, a flow of melt into a plurality of melt sub flows. The housing 740 and the flow divider insert 750 cooperate to define a plurality of melt conditioning channels 720 upstream of manifold flow channels 926g, each manifold flow channel 926g including a three-way first split 786 into branch manifold flow channels 926h.

It is noted that the foregoing has outlined some of the more pertinent non-limiting embodiments. It will be clear to those skilled in the art that modifications to the disclosed non-embodiment(s) can be effected without departing from the spirit and scope thereof. As such, the described non-limiting embodiment(s) ought to be considered to be merely illustrative of some of the more prominent features and applications. Other beneficial results can be realized by applying the non-limiting embodiments in a different manner or modifying the invention in ways known to those familiar with the art. This includes the mixing and matching of features, elements and/or functions between various non-limiting embodiment(s) is expressly contemplated herein so that one of ordinary skill in the art would appreciate from this disclosure that features, elements and/or functions of one embodiment may be incorporated into another embodiment as those skilled in the art would appreciate from this disclosure that features, elements and/or functions of one embodiment may be incorporated into another embodiment as appropriate, unless described otherwise, above. Although the description is made for particular arrangements and methods, the intent and concept thereof may be suitable and applicable to other arrangements and applications.

What is claimed is:

1. A melt conditioner (100, 200, 300, 400, 500, 600, 700) comprising a melt conditioning body (110, 210, 310, 410, 510, 610, 710), the melt conditioning body including a plurality of melt conditioning channels (120, 220, 320, 420, 520, 620, 720), the plurality of melt conditioning channels being located upstream of at least one manifold flow channel (926, 926a, 926b, 926c, 926d, 926e), each melt conditioning channel for conveying, in use, a melt sub flow and dimensioned to provide, in use, a conditioned melt sub flow having a thermal profile that accounts for a downstream geometry of the manifold flow channel.

2. The melt conditioner of claim 1, wherein each conditioned melt sub flow has a thermal profile that is optimized for the downstream geometry of the at least one manifold flow channel (926, 926a, 926b, 926c, 926d, 926e, 926f, 926g, 926h).

3. The melt conditioner of claim 1 or 2, wherein the melt conditioning body (110, 210, 310, 410, 510, 610, 710) is aligned relative to a manifold assembly (924) defining the at least one manifold flow channel (926, 926a, 926b, 926c, 926d, 926e, 926f, 926g, 926h) such that a flow of melt conveyed to the at least one manifold flow channel via the melt conditioning body has a predetermined thermal profile within the manifold flow channel.

4. The melt conditioner of any one of claims 1 to 3, wherein the plurality of melt conditioning channels (120, 220, 320, 420, 520, 620, 720) are uninterrupted.

5. The melt conditioner of claim 4, wherein the plurality of melt conditioning channels (120, 220, 320, 420, 520, 620, 720) are substantially parallel to each other.

6. The melt conditioner of any one of claims 1 to 5, wherein the melt conditioning body (110, 210) further includes a flow diverter (156, 256) defined at an upstream end (160, 260) of the melt conditioning body and configured to facilitate diverting the flow of melt to the plurality of melt conditioning channels (120, 220).

7. The melt conditioner of claim 6, wherein the flow diverter (156, 256) is conically shaped.

8. The melt conditioner of any one of claims 1 to 7, wherein the melt conditioning body (110, 310) further includes a flow recombination guide (158, 358) defined at a downstream end (170, 370) of the melt conditioning body and configured to facilitate recombining the plurality of melt sub flows to produce a split-conditioned melt flow.

9. The melt conditioner of any one of claims 1 to 7, wherein the melt conditioning body (110, 310) defines a recombination chamber (130, 330) located immediately downstream of the plurality of melt conditioning channels (120, 320), the plurality of conditioned melt sub flows being combined in the recombination chamber (130, 330) to produce a split-conditioned melt flow.

10. The melt conditioner of claim 8, wherein the melt conditioning body (110, 310) defines a recombination chamber (130, 330) located immediately downstream of the plurality of melt conditioning channels (120, 320), the plurality of conditioned melt sub flows being combined in the recombination chamber (130, 330) to produce the split-conditioned melt flow.

11. The melt conditioner of any one of claims 8-10, wherein the split-conditioned melt flow has an array of thermal profiles embedded therein.

12. The melt conditioner of claim 11, wherein the downstream geometry of the manifold flow channel includes a first split (186, 786) into a number of branch manifold flow channels (926b, 926h) and the number of thermal profiles embedded in the split-conditioned melt flow equals the number of branch manifold flow channels or a factor thereof.

13. The melt conditioner of any one of claims 1 to 12, wherein the melt conditioning body (110, 510, 710) further includes:
a housing (140, 540, 740); and
a flow divider insert (150, 550, 750) located in the housing, the flow divider insert being configured to split, in use, a flow of melt into a plurality of melt sub flows, the flow divider insert cooperating with the housing to define the plurality of melt conditioning channels (120, 520, 720).

14. The melt conditioner of claim 13, wherein the flow divider insert (150, 550) includes:
an elongated central portion (152); and
a plurality of fins (154) extending radially from the elongated central portion (152).

15. The melt conditioner of any one of claims 1 to 5, wherein the melt conditioning body (310, 410, 610) defines a plurality of melt inlets (314, 414, 614) defined at an upstream end (360, 460, 660) of the melt conditioning body.

16. The melt conditioner of any one of claims 1 to 7, wherein the melt conditioning body (210, 410, 610) includes a plurality of melt outlets (212, 412, 612) defined at a downstream end (270, 470, 670) of the melt conditioning body.

17. The melt conditioner of any one of claims 8 to 11, wherein the split-conditioned melt flow is splittable into a plurality of conditioned downstream melt sub flows, each conditioned downstream melt sub flow having substantially the same thermal profile.

18. The melt conditioner of any one of claims 1 to 17, wherein the melt conditioning body (110, 210, 310, 410, 510, 610) includes:
an upstream end (160, 260, 360, 460, 560, 660) configured to be connected to a melt preparation apparatus; and
a downstream end (170, 270, 370, 470, 570, 670) configured to be connected to a melt distributor.

19. The melt conditioner of any one of claims 1 to 17, wherein the melt conditioning body (510, 610) includes:
a downstream end (570, 670) configured to be connected to a melt distributor; and
an upstream end (560, 660) configured to be connected to a machine nozzle.

20. The melt conditioner of any one of claims 1 to 17, wherein the melt conditioning body (710) is configured as a manifold assembly.

21. The melt conditioner of any one of claims 1 to 18, wherein the melt conditioner (100, 200, 300, 400) is configured as a machine nozzle.

22. The melt conditioner of any one of claims 1 to 17 and 19, wherein the melt conditioner (500, 600) is configured as a sprue bushing.
